(19) United States
(12) Patent Application Publication
(10) Pub. No.: US 2025/0171918 A1
(43) Pub. Date: May 29, 2025

(54) A Separator for Alkaline Water Electrolysis

(71) Applicant: Agfa-Gevaert NV, Mortsel (BE)

(72) Inventors: Bart Verlinden, Mortsel (BE); Luc Brams, Mortsel (BE); Hanne Verwaest, Mortsel (BE); Willem Mues, Mortsel (BE)

(73) Assignee: Agfa-Gevaert NV, Mortsel (BE)

(21) Appl. No.: 18/859,608

(22) PCT Filed: Apr. 21, 2023
(86) PCT No.: PCT/EP2023/060464

§ 371 Date: Oct. 24, 2024

(30) Foreign Application Priority Data
Apr. 25, 2022 (EP) 22169862.4

(51) Int. Cl. C25B 13/08; C25B 1/04; C25B 9/19; C25B 13/02; C25B 13/05

(52) U.S. Cl. CPC C25B 13/08; C25B 1/04; C25B 9/19; C25B 13/02; C25B 13/05

(57) ABSTRACT

A separator for alkaline electrolysis (1) comprising a porous support (10), a first porous layer (20b) provided on one side of the porous support and a second porous layer (30b) provided on the other side of the porous support, wherein the first and the second porous layer are partially impregnated into the porous support and each have an overlay thickness d1 and d2 respectively, said overlay thickness being defined as the part of each porous layer which is not impregnated into the porous support, characterized in that a) d1 is smaller than the overlay thickness of the second porous layer (d2), and b) d1 is at least 20 μm.

### TECHNICAL FIELD

The present invention relates to a method of manufacturing a separator for alkaline water electrolysis and to separators obtained with the method.

### BACKGROUND ART

Nowadays, hydrogen is used in several industrial processes, for example as raw material in the chemical industry and as reducing agent in the metallurgic industry. Hydrogen is a fundamental building block for the manufacture of ammonia, and hence fertilizers, and of methanol, used in the manufacture of many polymers. Refineries, where hydrogen is used for the processing of intermediate oil products, are another area of use.

Hydrogen is also being considered an important future energy carrier, which means it can store and deliver energy in a usable form. Energy is released by an exothermic combustion reaction with oxygen thereby forming water. During such combustion reaction, no greenhouse gases containing carbon are emitted.

For the realization of a low-carbon society, renewable energies using natural energy such as solar light and wind power are becoming more and more important.

The production of electricity from wind power and solar power generation systems is very much dependent on the weather conditions. Because weather conditions are continuously varying, this results in an imbalance of demand and supply of electricity. To store surplus electricity, the so-called power-to-gas technology wherein electrical power is used to produce gaseous fuel such as hydrogen, attracted much interest in recent years. As production of electricity from renewable energy sources will increase, the demand for storage and transportation of the produced energy will also increase.

Alkaline water electrolysis is an important manufacturing process in which electricity may be converted into hydrogen.

In an alkaline water electrolysis cell, a so-called separator or diaphragm is used to separate the electrodes of different polarity to prevent a short circuit between these electronic conducting parts (electrodes) and to prevent the recombination of hydrogen (formed at the cathode) and oxygen (formed at the anode) by avoiding gas crossover. While serving in all these functions, the separator should also be a highly ionic conductor for transportation of hydroxyl ions from the cathode to the anode.

A separator typically includes a porous support. Such a porous support reinforces the separator facilitating the manipulation of the separator and the introduction of the separator in an electrolyser as disclosed in EP-A 232923 (Hydrogen Systems).

EP-A 3312306 (Kawasaki/De Nora/ThyssenKrupp) discloses a membrane with a porous support and a polymer porous membrane impregnated in the porous support. The membrane forming solution is applied to one of the surfaces of the support, possibly resulting in a double coated membrane with porous layers on both surfaces of the support having a significantly different thickness.

EP-A 1776490 (VITO) discloses a process of preparing a reinforced separator. The process leads to a membrane with symmetrical characteristics. The process includes the steps of providing a porous support as a web and a suitable dope solution, guiding the web in a vertical position, equally coating both sides of the web with the dope solution to produce a web coated support, and applying a symmetrical surface pore formation step and a symmetrical coagulation step to the dope coated web to produce a reinforced membrane.

WO2009/147084 and WO2009/147086 (Agfa-Gevaert and VITO) disclose manufacturing methods to produce a reinforced membrane with symmetrical characteristics as described in EP-A 1776490. The porous support used in these manufacturing methods have a thickness of more than 190 μm.

The advantage of a membrane with symmetrical characteristics is an increased robustness, since the occurrence of a defect on one side of the support is not detrimental on the overall performance of the membrane.

EP-A 3933069 (Agfa-Gevaert) discloses a reinforced separator with symmetrical characteristics comprising a porous support having a thickness of 150 μm or less and a thickness of the membrane of less than 250 μm. The membrane has improved ion conductivity and sufficient mechanical properties. By adjusting the viscosity of the dope solution, a membrane with sufficient flatness and less waviness was obtained.

However, it has been observed that during the manufacturing process of the double-sided reinforced separators, waviness/flatness of the support may remain a problem, resulting in a separator having waviness. Such waviness may result in performance problems of the electrolyser.

Therefore, there is still a need for membranes with a minimal waviness, high ion conductivities and sufficient gas separation properties.

### SUMMARY OF INVENTION

An object of the invention is to provide a separator with minimal waviness, a high ion conductivity and good gas separation properties. Surprisingly, it was found that when a separator has different overlay thicknesses d1 and d2 as defined in claim 1 it has minimal waviness, a high ion conductivity and sufficient gas separating properties.

It is another object of the invention to provide a method of preparing such a separator.

Further objects of the invention will become apparent from the description hereinafter.

### BRIEF DESCRIPTION OF DRAWINGS

FIG. 1 schematically shows an embodiment of a separator according to the present invention.

FIG. 2 schematically shows an embodiment of a manufacturing method of a separator according to the present invention.

FIG. 3 schematically shows another embodiment of a manufacturing method of a separator according to the present invention.

FIG. 4 is a microscopy image of a cross section of a separator according to the present invention, illustrating the overlay thicknesses d1 and d2 by showing several distances for d1 and for d2, represented by d1(1), d1(2), d1(3), d2(1), d2(2), d2(3). Multiple lines are drawn to be able to calculate an average.

FIG. 5 is an image of a separator showing waviness.

### DESCRIPTION OF EMBODIMENTS

### Separator for Alkaline Electrolysis

The separator for alkaline water electrolysis (1) according to the present invention comprises a porous support (10) and a first (20b) and second (30b) porous layer provided on respectively one side and the other side of the porous support, characterized in that
a) the first porous layer has an overlay thickness (d1) smaller than the overlay thickness of the second porous layer (d2) and
b) the overlay thickness of the first porous layer (d1) is at least 20 μm, preferably at least 30 μm, more preferably at least 35 μm, most preferably at least 40 μm.

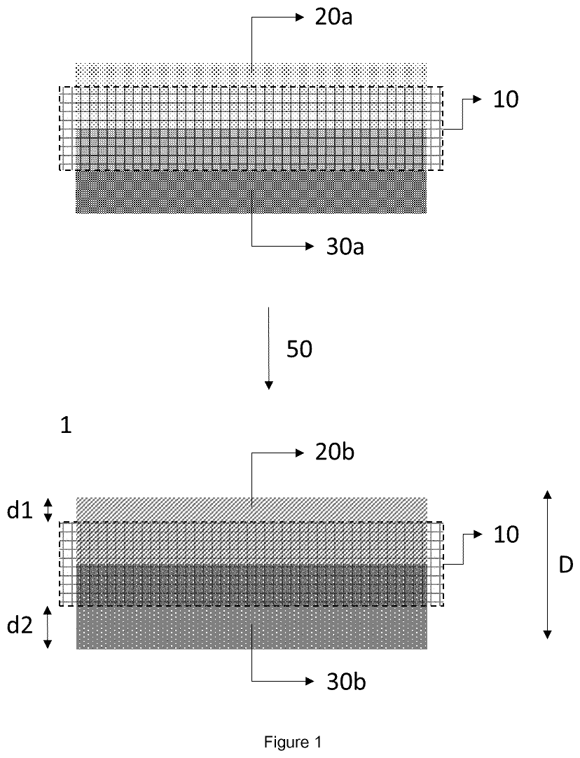

The overlay of a porous layer is defined as the part of the porous layer that is not impregnated in the porous support (see FIG. 1). The overlay thickness of the porous layer may be microscopically determined as described further.

Surprisingly, it was found that waviness could be reduced when the overlay thicknesses d1 and d2 are different from each other. The overlay thickness of the first porous layer d1 is at least 20 μm. When d1 is less than 20 μm, it is possible that fibres from the porous support will protrude the overlay of the porous layer, resulting in a too high gas permeability. A too high gas permeability can result in a too high flow of electrolyte, which could bring dissolved gas to the wrong side of the electrolyser, resulting in an increase of the HTO (vol % hydrogen present in the oxygen formed at the anode).

Preferably, the ratio of the overlay thicknesses d1/d2 is less than 0.8, more preferably less than 0.6, most preferably less than 0.4. If d1/d2 is larger than 0.8, the separator may have waviness.

The total thickness of the separator (D) is preferably 250 μm or less, more preferably 225 μm or less, most preferably 175 μm or less, particularly preferred 150 μm or less. If the thickness of the separator is less than 100 μm, its physical strength may become insufficient, when the thickness is above 250 μm, the electrolysis efficiency may decrease.

The gas permeability of the membrane is preferably between 1 and 7 L/min·cm², more preferably between 1.5 and 6.5 L/min·cm², most preferably between 2 and 5.5 L/min·cm². The gas permeability may be measured with a Porolux™ 1000 apparatus at 5 bar.

The separator preferably has an ionic resistance (also called area specific resistance) of less than 0.1 ohm·cm², more preferably less than 0.07 ohm·cm² at 80° C. in a 30 wt % aqueous KOH solution. The ionic resistance may be determined with an Inolab® Multi 9310 IDS apparatus available from VWR, part of Avantor, equipped with a TetraCon 925 conductivity cell available from Xylem.

As described below in more detail, a separator according to the present invention is preferably prepared by the application of a coating solution on both surfaces of a porous support. This coating solution is also referred to as a dope solution, typically comprising a polymer resin, hydrophilic inorganic particles, and a solvent. The porous layer is then obtained after a phase inversion step wherein the polymer resin forms a three-dimensional porous polymer network.

The separator according to the present invention having different overlay thicknesses on both sides of the porous support is preferably obtained by adjusting the flow rate at the slot coating dies, which is described further in more detail.

Upon application of the dope solutions on both surfaces of the porous support, the dope solutions impregnate the porous support. The porous support is preferably completely impregnated with the dope solutions.

The first and the second porous layers provided on the porous support may have the same or a different composition, and may have the same or a different bubble point.

After phase inversion, the impregnation of the porous support ensures that the three-dimensional porous polymer network also extends into the porous support. This results in a good adhesion between the porous layer and porous support.

A preferred separator (1) is schematically shown in FIG. 1.

A dope solution has been applied on both sides of a porous support (10) and the porous support is fully impregnated with the applied dope solution. The applied dope layers are referred to as 20a and 30a.

After a phase inversion step (50), a separator (1) is obtained comprising a porous support (10) and on either side of the support a porous layer (20b, 30b).

The separator includes pores having a pore diameter that is sufficiently small to prevent gas crossover. On the other hand, to ensure efficient transportation of hydroxyl ions from the cathode to the anode, larger pore diameters are preferred. An efficient transportation of the hydroxyl ions requires an efficient penetration of electrolyte into the separator.

The pores are preferably characterized using the Bubble Point Test method described in American Society for Testing and Materials Standard (ASMT) Method F316. This technique is based on the displacement of a wetting liquid embedded in the separator by applying an inert pressurised gas. Only through-pores are measured in this way.

The most challenging part for the gas to displace the liquid along the entire pore path is the most constricted section of the pore, also known as pore throat. The diameter of a pore measured with the Bubble Point Test method is the diameter of that pore throat, regardless of where the pore throat is positioned in the pore path.

The pore diameters referred to herein are all measured using the Bubble Test method described above.

The maximum pore diameter (PDmax) of the separator is preferably between 0.05 and 2 μm, more preferably between 0.10 and 1 μm, most preferably between 0.2 and 0.6 μm.

The average pore diameter of the separator is preferably between 0.01 and 1 μm, more preferably between 0.02 and 0.5 μm, most preferably between 0.05 and 0.25 μm.

The Bubble Point Test method may be adapted to measure a maximum pore diameter (PDmax) on both sides of a separator by using a grid supporting one side of the separator during the measurement. Another measurement is then carried out using the grid supporting to other side of the separator.

Both sides of the separator may have identical or different maximum pore diameters.

Preferred separators have a maximum pore diameter PDmax(1) on one side and a maximum pore diameter PDmax(2) on the other side wherein both PDmax(1) and PDmax(2) are from 0.05 and 2 μm, more preferred from 0.10 to 1 μm, most preferred from 0.15 to 0.5 μm and wherein the ratio PDmax(1)/PDmax(2) is from 0.9 to 1.1, more preferred from 0.95 to 1.05.

However, the separator may also have maximum pore diameters PDmax(1) and PDmax(2) that are substantially different from each other, for example to avoid trapping of gas bubbles inside the separator. For example a separator having on one side a maximum pore diameter PDmax(1) from 0.05 to 0.3 μm, more preferably from 0.08 to 0.25 μm, most preferably from 0.1 to 0.2 μm and on the other side a maximum pore diameter PDmax(2) from 0.2 to 6.5 μm, more preferably from 0.2 to 1.50 μm, most preferably from 0.2 to 0.5 μm.

The ratio between PDmax(2) and PDmax(1) is preferably from 1.1 to 20, more preferably from 1.25 to 10, most preferably from 2 to 7.5. The smaller PDmax(1) ensure an efficient separation of hydrogen and oxygen while PDmax(2) ensures a good penetration of the electrolyte in the separator resulting in a sufficient ionic conductivity.

The porosity of the separator is preferably between 30 and 80%, more preferably between 50 and 70%. A separator having a porosity within the above ranges typically has excellent ion permeability and excellent gas barrier properties because the pores of the diaphragm are continuously filled with an electrolyte solution.

### Porous Support

The porous support is used to reinforce the separator to ensure its mechanical strength.

It has been observed that the ion conductivity through a reinforced separator increases when the thickness of the porous support decreases.

Therefore, the thickness of the porous support is preferably 150 μm or less, more preferably 125 μm or less, most preferably 100 μm or less, particularly preferred 75 μm or less.

However, to ensure sufficient mechanical properties of the reinforced separator, the thickness of the porous support is preferably 20 μm or more, more preferably 40 μm or more, most preferably 50 μm or more.

The porous support may be selected from the group consisting of a porous fabric and a porous ceramic plate.

The porous support is preferably a non-woven fabric, a woven fabric, a mesh or a felt, more preferably a non-woven or woven fabric.

The porous support is preferably a porous fabric, more preferably a porous polymer fabric.

The porous polymer fabric may be woven or non-woven. Woven fabrics typically have a better dimensional stability and homogeneity of open area and thickness. However, the manufacture of woven fabrics with a thickness of 100 μm or less is more complex resulting in more expensive fabrics. The manufacture of non-woven fabrics is less complex, even for fabrics having a thickness of 100 μm or less. Also, non-woven fabrics may have a larger open area.

The open area of the porous support is preferably between 30 and 80%, more preferably between 40 and 70%, to ensure a good penetration of the electrolyte into the support.

The fabric preferably has a fibre diameter from 20 μm to 200 μm, more preferably from 40 μm to 150 μm, most preferably from 60 μm to 100 μm. Thin fabrics preferably have a smaller fibre diameter. For example, a fabric having a thickness of 150 μm or lower preferably have a fibre diameter of 75 μm or lower, more preferably of 50 μm or lower, most preferably of 35 μm or lower.

To further reduce the thickness of the fabric, the ratio of the gauze thickness to the fibre diameter is preferably less than 2.0, more preferably 1.7 or less, most preferably 1.4 or less. A thinner fabric makes it possible to prepare thinner separators.

Suitable porous polymer fabrics are prepared from polypropylene (PP), polyethylene (PE), polysulfone (PSU), polyphenylene sulfide (PPS), polyamide/nylon (PA), polyether sulfone (PES), polyphenyl sulfone (PPSU), polyethylene terephthalate (PET), polyether-ether ketone (PEEK), sulfonated polyether-ether keton (s-PEEK), monochlorotrifluoroethylene (CTFE), copolymers of ethylene with tetrafluorethylene (ETFE) or chlorotrifluorethylene (ECTFE), polyimide, polyether imide and m-aramide.

A preferred polymer fabric is prepared from polypropylene (PP), polyether ether ketone (PEEK) or polyphenylene sulfide (PPS), most preferably from polyether ether ketone (PEEK) or polyphenylene sulfide (PPS)

A PPS or PEEK-based porous support has a high resistance to high-temperature, high concentration alkaline solutions and a high chemical stability against active oxygen evolved from an anode during the water electrolysis process. Also, PPS and PEEK can be easily processed into various forms such as a woven fabric or a non-woven fabric.

The density of the porous support is preferably between 0.1 to 0.7 g/cm³.

The porous support is preferably a continuous web to enable a manufacturing process as disclosed in EP-A 1776490 and WO2009/147084.

The width of the web is preferably between 30 and 300 cm, more preferably between 40 and 200 cm.

### Polymer Resin

The porous layer preferably comprises a polymer resin.

The polymer resin forms a three dimensional porous network, the result of a phase inversion step in the preparation of the separator, as described below.

The polymer resin may be selected from a fluorine resin such as polyvinylidene fluoride (PVDF) and polytetrafluoroethylene (PTFE), an olefin resin such as polypropylene (PP), and an aromatic hydrocarbon resin such as polyethylene terephthalate (PET) and polystyrene (PS). The polymer resins may be used alone, or two or more of the polymer resins may be used in combination.

PVDF and vinylidenefluoride (VDF)-copolymers are preferred for their oxidation/reduction resistance and film-forming properties. Among these, terpolymers of VDF, hexanefluoropropylene (HFP) and chlorotrifluoroethylene (CTFE) are preferred for their excellent swelling properties, heat resistance and adhesion to electrodes.

Another preferred polymer resin is an aromatic hydrocarbon resin for their excellent heat and alkali resistance. Examples of an aromatic hydrocarbon resin include polyethylene terephthalate, polybutylene terephthalate, polybutylene naphthalate, polystyrene, polysulfone, polyethersulfone, polyphenylene sulfide, polyphenyl sulfone, polyacrylate, polyetherimide, polyimide, and polyamide-imide.

A particular preferred polymer resin is selected from the group consisting of polysulfone, polyethersulfone, polyphenylene sulfide, polyether ether ketone and polyphenylsulfone, polysulfone being the most preferred.

The molecular weight (Mw) of the polymer resin is preferably between 10 000 and 500 000, more preferably between 25 000 and 250 000. When the Mw is too low, the physical strength of the porous layer may become insufficient. When the Mw is too high, the viscosity of the dope solution may become too high.

Examples of polysulfones, polyether sulfones and combinations thereof are disclosed in EP-A 3085815, paragraphs [0021] to [0032].

### Inorganic Hydrophilic Particles

The hydrophilic layer preferably comprises hydrophilic inorganic particles.

Preferred hydrophilic inorganic particles are selected from metal oxides and metal hydroxides.

Preferred metal oxides are selected from the group consisting of zirconium oxide, titanium oxide, bismuth oxide, cerium oxide and magnesium oxide.

Preferred metal hydroxides are selected from the group consisting of zirconium hydroxide, titanium hydroxide, bismuth hydroxide, cerium hydroxide and magnesium hydroxide. A particularly preferred magnesium hydroxide is disclosed in EP-A 3660188, paragraphs [0040] to [0063].

Other preferred hydrophilic inorganic particles are barium sulfate particles as disclosed in EP-A 3994295.

Other hydrophilic particles that may be used are nitrides and carbides of Group IV elements of the periodic table.

The hydrophilic inorganic particles preferably have a D50 particle size of 0.05 to 2.0 μm, more preferably of 0.1 to 1.5 μm, most preferably of 0.15 to 1.00 μm, particularly preferred of 0.2 to 0.75 μm. The D50 particle size is preferably less than or equal to 0.7 μm, preferably less than or equal to 0.55 μm, more preferably less than or equal to 0.40 μm.

The D50 particle size is also known as the median diameter or the medium value of the particle size distribution. It is the value of the particle diameter at 50% in the cumulative distribution. For example, if D50=1.0 um, then 50% of the particles are larger than 1.0 um, and 50% are smaller than 1.0 um.

The D50 particle size is preferably measured using laser diffraction, for example using a Mastersizer from Malvern Panalytical.

The amount of the hydrophilic particles relative to the total dry weight of the porous layer is preferably at least 50 wt %, more preferably at least 75 wt %.

The weight ratio of hydrophilic particles to polymer resin is preferably more then 60/40, more preferably more than 70/30, most preferably more than 75/25.

### Preparation of the Separator

A preferred preparation method of the separator described above comprises the steps of:
applying a dope solution as described below on both sides of a porous substrate; and
performing phase inversion on the applied dope solutions thereby forming a first and a second porous layer on respectively one and the other side of the porous support, characterized in that
   a) the first porous layer has an overlay thickness (d1) smaller than the overlay thickness of the second porous layer (d2).

The separator according to the invention is preferably obtained by the above method.

In a preferred embodiment, the overlay thickness of the first porous layer (d1) is at least 20 μm, preferably at least 30 μm, more preferably at least 35 μm, most preferably at least 40 μm.

A preferred method of manufacturing a reinforced separator is disclosed in EP-A 1776490, WO2009/147084 and EP-A 3652362. These methods result in web-reinforced separators wherein the web, i.e. the porous support, is nicely embedded in the separator, without appearance of the web at a surface of the separator.

Other manufacturing methods that may be used are disclosed in EP-A 3272908.

### Dope Solution

The dope solution preferably comprises a polymer resin as described above, hydrophilic inorganic particles as described above and a solvent.

The solvent of the dope solution is preferably an organic solvent wherein the polymer resin can be dissolved. Moreover, the organic solvent is preferably miscible in water.

The solvent is preferably selected from N-methyl-pyrrolidone (NMP), N-ethyl-pyrrolidone (NEP), N-butyl-pyrrolidone (NBP), N,N-dimethylformamide (DMF), formamide, dimethylsulfoxide (DMSO), N,N-dimethylacetamide (DMAC), acetonitrile, and mixtures thereof.

A highly preferred solvent, for health and safety reasons, is N-butyl-pyrrolidone (NBP).

The dope solution may further comprise other ingredients to optimize the properties of the obtained polymer layers, for example their porosity and the maximum pore diameter at their outer surface.

The dope solution preferably comprises an additive to optimize the pore size at the surface and inside of the porous layer. Such additives may be organic or inorganic compounds, or a combination thereof.

Organic compounds which may influence the pore formation in the porous layers include polyethylene glycol, polyethylene oxide, polypropylene glycol, ethylene glycol, tripropylene glycol, glycerol, polyhydric alcohols, dibutyl phthalate (DBP), diethyl phthalate (DEP), diundecyl phthalate (DUP), isononanoic acid or neodecanoic acid, polyvinylpyrrolidone, polyvinyl-alcohol, polyvinylacetate, polyethyleneimine, polyacrylic acid, methylcellulose and dextran.

Preferred organic compounds which may influence the pore formation in the porous layers are selected from polyethylene glycol, polyethylene oxide and polyvinyl pyrrolidone.

A preferred polyethylene glycol has a molecular weight of from 10 000 to 50 000, a preferred polyethylene oxide has a molecular weight of from 50 000 to 300 000, and a preferred polyvinylpyrrolidone has a molecular weight of from 30 000 to 1 000 000.

A particularly preferred organic compound which may influence the pore formation in the porous layers is glycerol.

The amount of compounds which may influence the pore formation is preferably between 0.1 and 15 wt %, more preferably between 0.5 and 5 wt % relative to the total weight of the dope solution.

Inorganic compounds which may influence the pore formation include calcium chloride, magnesium chloride, lithium chloride and barium sulfate.

A combination of two or more additives that influence the pore formation may be used.

The dope solutions provided on either side of the porous support may be the same or different.

### Applying the Dope Solution

The dope solution may be applied on the surface of a substrate, preferably a porous support, by any coating or casting technique.

A preferred coating technique is extrusion coating.

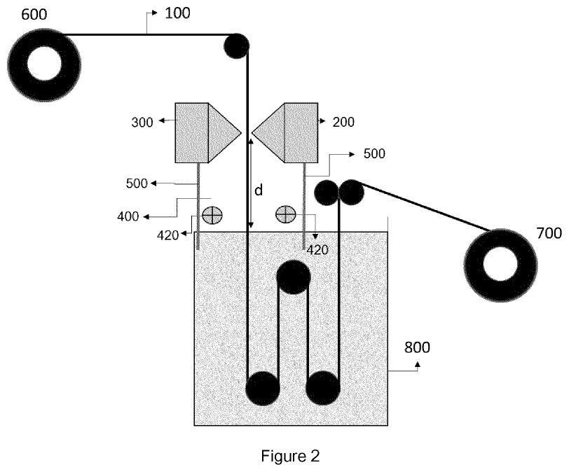

In a highly preferred embodiment, the dope solutions are applied by a slot die coating technique wherein two slot coating dies (FIGS. 2 and 3, 200 and 300) are located on either side of a porous support.

The slot coating dies are capable of holding the dope solution at a predetermined temperature, distributing the dope solutions uniformly over the support, and adjusting the coating thickness of the applied dope solutions.

The viscosity of the dope solutions measured at a shear rate of 100 s⁻¹ and a temperature of 20° C. is preferably between 1.0 and 30.0 Pa·s, more preferably between 5.0 and 20.0 Pa·s, most preferably between 7.5 and 15.0 Pa·s.

The dope solutions are preferably shear-thinning. The ratio of the viscosity at a shear rate of 1 s⁻¹ to the viscosity at a shear rate of 100 s⁻¹ is preferably at least 2, more preferably at least 2.5, most preferably at least 5.

The flow rate Q of the dope solutions at the slot coating dies can be the same or different.

To prepare the separator according to the invention, the dope solutions are preferably applied by adjusting the flow rate Q of the slot coating dies such that the flow rate Q₁ at the first slot coating die (200) is different than the flow rate Q₂ at the second slot coating die (300). The difference in flow rate Q₁-Q₂ is called AQ. The sum of the flow rates Q₁+Q₂ is called Q_{TOT}.

If there is no difference in flow rates (ΔQ is zero) or only a small difference, there is a higher chance of waviness in the separator.

If the difference in flow rates is too high, it is possible that the overlay thickness (d1) of the first porous layer is less than 20 μm, resulting in a too high gas permeability of the separator. If ΔQ=Q_{TOT}, the substrate may only be coated on one side.

The difference in flow rate ΔQ is preferably more than zero and less than Q_{TOT}. The difference in flow rate at the slot coating dies is preferably such that Q₁/Q₂ is more than 0 and less than 1. Q₁/Q₂ is preferably from 0.1 to 0.9, more preferably from 0.2 to 0.8, most preferably from 0.3 to 0.7.

The open area of the porous support may determine how large the difference in flow rates may be. When there is more open area, ΔQ may need to be larger to reduce waviness. When there is less open area in the porous support, ΔQ can be smaller in order to obtain minimal waviness.

The separator according to the invention is preferably obtained by a method wherein the flow rate Q of the dope solutions at the slot coating dies is adjusted such that the flow rate Q₁ at the first slot coating die (200) is different than the flow rate Q₂ at the second slot coating die (300), more preferably wherein Q₁/Q₂ is from 0.1 to 0.9, more preferably from 0.2 to 0.8, most preferably from 0.3 to 0.7.

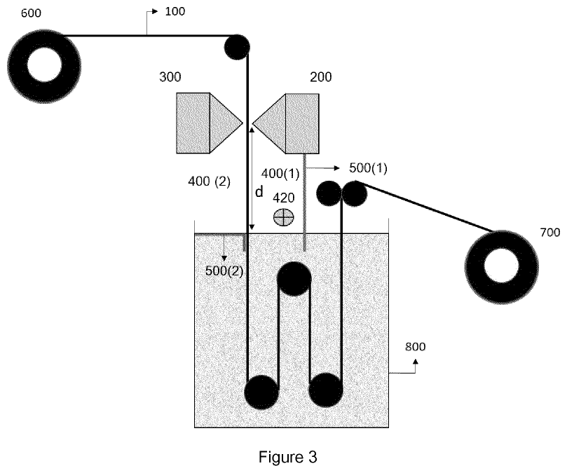

The porous support is preferably a continuous web, which is transported downwards between the slot coating dies (200, 300) as shown in FIGS. 2 and 3.

Immediately after the application, the porous support becomes impregnated with the dope solutions.

Preferably, the porous support becomes fully impregnated with the applied dope solutions.

### Phase Inversion Step

After applying the dope solution onto a porous support, the applied dope solution is subjected to phase inversion. In the phase inversion step, the applied dope solution is transformed into a porous hydrophilic layer.

In a preferred embodiment, both dope solutions applied on a porous support are subjected to phase inversion.

Any phase inversion mechanism may be used to prepare the porous hydrophilic layers from the applied dope solutions.

The phase inversion step preferably includes a so-called Liquid Induced Phase Separation (LIPS) step, a Vapour Induced Phase Separation (VIPS) step or a combination of a VIPS and a LIPS step. The phase inversion step preferably includes both a VIPS and a LIPS step.

Both LIPS and VIPS are non-solvent induced phase-inversion processes.

In a LIPS step the porous support coated on both sides with the dope solution is contacted with a non-solvent that is miscible with the solvent of the dope solution.

Typically, this is carried out by immersing the porous support coated on both sides with the dope solutions into a non-solvent bath, also referred to as coagulation bath.

The non-solvent is preferably water, mixtures of water and an aprotic solvent selected from the group consisting of N-methylpyrrolidone (NMP), N-ethyl-pyrrolidone (NEP), N-butyl-pyrrolidone (NBP), dimethylformamide (DMF), dimethylsulfoxide (DMSO) and dimethylacetamide (DMAC), water solutions of water-soluble polymers such as PVP or PVA, or mixtures of water and alcohols, such as ethanol, propanol or isopropanol.

The non-solvent is most preferably water.

The temperature of the coagulation bath is preferably between 2° and 90° C., more preferably between 4° and 70° C.

The transfer of solvent from the coated polymer layer towards the non-solvent bath and of non-solvent into the polymer layer leads to phase inversion and the formation of a three-dimensional porous polymer network. The impregnation of the applied dope solution into the porous support results in a sufficient adhesion of the obtained hydrophilic layers onto the porous support.

In a preferred embodiment, the continuous web (100) coated on either side with a dope solution is transported downwards, in a vertical position, towards the coagulation bath (800) as shown in FIGS. 2 and 3.

In a VIPS step, the porous support coated with the dope solutions is exposed to non-solvent vapour, preferably humid air.

Preferably, the coagulation step included both a VIPS and a LIPS step. Preferably the VIPS step is carried out before the LIPS step. In a particular preferred embodiment, the porous support coated with the dope solutions is first exposed to humid air (VIPS step) prior to immersion in a water bath (LIPS step).

In the manufacturing method shown in FIG. 2, VIPS is carried out in the area 400, between the slot coating dies (200, 300) and the surface of the non-solvent in the coagulation bath (800), which is shielded from the environment with for example thermal isolated metal plates (500).

The extent and rate of water transfer in the VIPS step can be controlled by adjusting the velocity of the air, the relative humidity and temperature of the air, as well as the exposure time.

The exposure time may be adjusted by changing the distance d between the slot coating dies (200, 300) and the surface of the non-solvent in the coagulation bath (800) and/or the speed with which the elongated web 100 is transported from the slot coating dies towards the coagulation bath.

The relative humidity in the VIPS area (400) may be adjusted by the temperature of the coagulation bath and the shielding of the VIPS area (400) from the environment and from the coagulation bath.

The speed of the air may be adjusted by the rotating speed of the ventilators (420) in the VIPS area (400).

The VIPS step carried out on one side of the separator and on the other side of the separator, resulting in the second porous polymer layer, may be identical (FIG. 2) or different (FIG. 3) from each other.

After the phase inversion step, preferably the LIPS step in the coagulation bath, a washing step may be carried out.

After the phase inversion step, or the optional washing step, an optional drying step is carried out.

### Manufacturing of the Separator

FIGS. 2 and 3 schematically illustrate a preferred embodiment to manufacture a separator according to the present invention.

The porous support is preferably a continuous web (100).

The web is unwinded from a feed roller (600) and guided downwards in a vertical position between two coating units (200) and (300).

With these coating units, a dope solution is coated on either side of the web. The coating thickness on either side of the web may be adjusted by optimizing the flow rates as described above, the viscosity of the dope solutions and the distance between the coating units and the surface of the web. Preferred coating units are described in EP-A 2296825, paragraphs [0043], [0047], [0048], [0060], [0063], and FIG. 1.

The web coated on both sides with a dope solution is then transported over a distance d downwards towards a coagulation bath (800).

In the coagulation bath, the LIPS step is carried out.

The VIPS step is carried out before entering the coagulation bath in the VIPS areas. In FIG. 2, the VIPS area (400) is identical on both sides of the coated web, while in FIG. 3, the VIPS areas (400(1)) and (400(2)) on either side of the coated web are different.

The relative humidity (RH) and the air temperature in de VIPS area may be optimized using thermally isolated metal plates. In FIG. 2, the VIPS area (400) is completely shielded from the environment with such metal plates (500). The RH and temperature of the air is then mainly determined by the temperature of the coagulation bath. The air speed in the VIPS area may be adjusted by a ventilator (420).

In FIG. 3 the VIPS areas (400(1)) and (400(2)) are different from each other. The VIPS area (400(1)) on one side of the coated web including a metal plate (500(1)) is identical to the VIPS area (400) in FIG. 2. The VIPS area (400(2)) on the other side of the coated web is different from the area (400(1)). There is no metal plate shielding the VIPS area (400(2)) from the environment. However, the VIPS area (400(2)) is now shielded from the coagulation bath by a thermally isolated metal plate (500(2)). In addition, there is no ventilator present in the VIPS area 400(2). This results in a VIPS area (400(1)) having a higher RH and air temperature compared to the RH and air temperature of the other VIPS area (400(2)).

A high RH and/or a high air speed in a VIPS area typically result in a larger maximum pore diameter.

The RH in one VIPS area is preferably above 85%, more preferably above 90%, most preferably above 95% while the RH in another VIPS area is preferably below 80%, more preferably below 75%, most preferably below 70%.

After the phase separation step, the reinforced separator is then transported to a rolled up system (700).

A liner may be provided on one side of the separator before rolling up the separator and the applied liner.

### Electrolyser

The separator for alkaline water electrolysis according to the present invention may be a used in an alkaline water electrolyser.

An electrolysis cell typically consists of two electrodes, an anode and a cathode, separated by a separator. An electrolyte is present between both electrodes.

When electrical current is supplied to the electrolysis cell, hydroxyl ions of the electrolyte are oxidized into oxygen at the anode and water is reduced to hydrogen at the cathode. The hydroxyl ions formed at the cathode migrate through the separator to the anode. The separator prevents mixing of the hydrogen and oxygen gases formed during electrolysis.

An electrolyte solution is typically an alkaline solution. Preferred electrolyte solutions are aqueous solutions of electrolytes selected from sodium hydroxide or potassium hydroxide. Potassium hydroxide electrolytes are often preferred due to their higher specific conductivity. The concentration of the electrolyte in the electrolyte solution is preferably from 20 to 40 wt %, relative to the total weight of the electrolyte solution.

The temperature of the electrolyte is preferably from 50° C. to 120° C., more preferably from 75° C. to 100° C., most preferably from 80 to 90° C. However, a higher temperature, for example at least 100° C., more preferably from 125 to 165° C. may result in a more efficient electrolysis.

An electrode typically include a substrate provided with a so-called catalyst layer. The catalyst layer may be different for the anode, where oxygen is formed, and the cathode, where hydrogen is formed.

Typical substrates are made from electrically conductive materials selected from the group consisting of nickel, iron, soft steels, stainless steels, vanadium, molybdenum, copper, silver, manganese, platinum group elements, graphite, and chromium. The substrates may be made from an electrically conductive alloy of two or more metals or a mixture of two or more electrically conductive materials. A preferred material is nickel or nickel-based alloys. Nickel has a good stability in strong alkaline solutions, has a good conductivity and is relatively cheap.

A catalyst layer preferably includes nickel, cobalt, iron, and platinum group elements. The catalyst layer may include these elements as elemental metals, compounds (e.g. oxides), composite oxides or alloys made of multiple metal elements, or mixtures thereof. Preferred catalyst layers include plated nickel, plated alloys of nickel and cobalt or nickel and iron, complex oxides including nickel and cobalt such as LaNiO3, LaCoO3, and NiCo2O4, compounds of platinum group elements such as iridium oxide, or carbon materials such as graphene.

A particularly preferred catalyst layer comprises Raney Nickel. The Raney nickel structure is formed by selectively leaching aluminium or zinc from a Ni—Al or Ni—Zn alloy. Lattice vacancies formed during leaching result in a large surface area and a high density of lattice defects, which are active sites for the electrocatalytic reaction to take place.

Preferred porous electrodes and methods to prepare them are disclosed in for example EP-A 3575442, paragraphs 23 to 84.

The pore size of porous electrodes may have an influence on the electrolysis efficiency. For example, in EP-A 3575442 it is disclosed that preferred pore sizes of the porous electrodes are from 10 nm up to 200 nm.

The catalyst layer may also include organic substances such as polymers to improve the durability and the adhesion towards the substrate.

In a so-called zero gap electrolytic cell the electrodes are placed directly in contact with the separator thereby reducing the space between both electrodes. Mesh-type or porous electrodes are used to enable the separator to be filled with electrolyte and for efficient removal of the oxygen and hydrogen gases formed. It has been observed such zero gap electrolytic cells operate at higher current densities.

However, in such a zero gap electrolytic cell it has been observed that gas bubbles formed inside the separator may accumulate at the top of the separator. Such accumulation of gas bubbles at the top of the separator may result in a higher ionic resistance in that part of the cell. A temperature rise as a result of a less efficient cooling by the electrolyte in that area of the electrolysis cell may even result in burning of the separator.

It has been observed that introducing a small distance between one side of the separator and at least one electrode results in less accumulation of gas bubbles inside the separator. The distance between one side of the separator and the anode and the distance between the other side of the separator and the cathode may be the same or different.

The distance between a surface of the separator and at least one electrode is preferably from 50 up to 500 μm, more preferably from 100 up to 250 μm.

A so-called spacer may be used to realize the distance between the separator and the electrode.

Such a spacer is preferably hydrophilic to avoid adhesion of gas bubbles to the spacer (static water contact angle is 90° C. or lower, preferably 45° C. or lower).

Such a spacer preferably has an open structure to ensure rapid and sufficient evacuation of gas bubbles.

A typical alkaline water electrolyser includes several electrolytic cells, also referred to stack of electrolytic cells.

Regarding the cell configuration, two types of electrolysers are typically used.

A unipolar (or “tank-type”) electrolyser consists of alternate positive and negative electrodes held apart by a separator. Positive electrodes are all coupled together in parallel, as are the negative electrodes, and the whole assembly is immersed in a single electrolyte bath (“tank”) to form a unit cell. A plant-scale electrolyser is then built up by connecting these units electrically in series. The total voltage applied to the whole electrolysis cell is the same as that applied to the individual unit cells.

On the other hand, in a bipolar electrolyser a metal sheet (or “bipole”) connects electrically adjacent cells in series. The electrocatalyst for the negative electrode is coated on one face of the bipole and that for the positive electrode of the adjacent cell is coated on the reverse face. In this case, the total cell voltage is the sum of the individual unit cell voltages. Therefore, a series-connected stack of such cells forms a module that operates at a higher voltage and lower current than the tank-type (unipolar) design. To meet the requirements of a large electrolysis plant, these modules are connected in parallel so as to increase the current.

Membrane Electrode Assemblies (MEA) can also be used in an electrolyser. Such MEAs are typically prepared by applying a separator, preferably without a reinforcing support, on at least one porous electrode. Such MEAs are for example disclosed in EP-A 2831312 (Agfa Gevaert), EP3277862 (De Nora) and WO2020/158719 (Nippon Shokubai). Such MEAs may also be used in the electrolysis method according to the present invention.

The catalyst layer referred to above may also be provided on a surface of the separator, resulting in a s-called Catalyst Coated Membrane (CCM).

Such a CCM may have an improved contact surface between the membrane surface and the catalyst layer resulting in a higher electrolysis efficiency.

The catalyst layer may be applied on the membrane surface by any deposition technique such as coating, spraying, inkjet printing, gravure printing, screen printing, 3D printing, vapour deposition techniques.

### EXAMPLES

### Materials

All materials used in the following examples were readily available from standard sources such as ALDRICH CHEMICAL Co. (Belgium) and ACROS (Belgium) unless otherwise specified. The water used was deionized water.

PPS-Fabric, a 100 μm thick woven polyphenylenesulfide fabric.

ZrO₂, zirconium oxide particles having a D50 particle size smaller than 1 μm measured with a Mastersizer available from Malvern Panalytical.

Polysulfone, Udel P1700 NT LCD, a polysulfone resin available from SOLVAY.

Glycerol, a pore widening agent, commercially available from MOSSELMAN.

NBP, N-butyl-pyrrolidone, commercially available from Taminco.

### Measurements

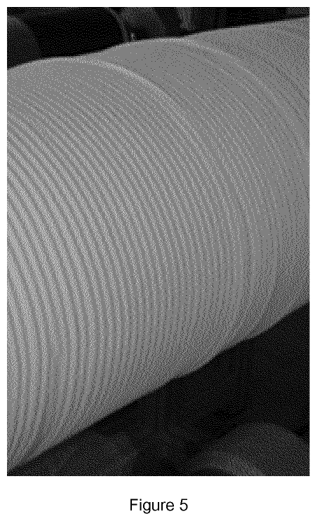

Flatness/waviness. The flatness/waviness of the separators was evaluated by visual inspection. FIG. 5 illustrates waviness observed in a separator.

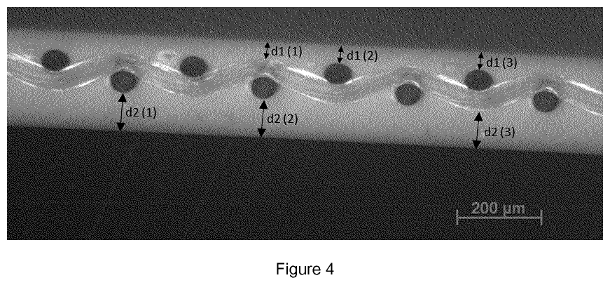

Overlay thickness. The overlay thickness of the porous layer is determined with optical microscopy. Prior to the imaging, the membrane is imbedded in epoxy resin and polished mechanically. Imaging is done with a Zeiss Discovery.V12 Stereomicroscope using ring light. Calibrated images are analysed with the measuring tool of Image Pro 10. The overlay thickness is measured by drawing multiple lines from the membrane edge perpendicular towards the outer edge of the mesh fiber, as is show in FIG. 4. By way of illustration, FIG. 4 shows several distances for d1 and for d2, represented by d1(1), d1(2), d1(3), d2(1), d2(2), d2(3). An average value for d1 and d2 is calculated from all the measured distances at 10 different spots on 5 images of 2 cm long cross-sections from 3 different samples.

Viscosity. The viscosity of the dope solution at 100 s⁻¹ and 20° C. was measured with a Kinexus LAB+Rheometer available from Malvern Panalytical using a “Cup&Bob” geometry.

Gas permeability. The gas permeability was measured with a Porolux™ 1000 apparatus at 5 bar.

### Example 1

### Preparation of the Separators S-1 to S-3

A dope solution was prepared by mixing the ingredients of Table 1.

TABLE 1

| Ingredients | wt % |
|---|---|
| ZrO₂ | 40.07 |
| Polysulfone | 10.02 |
| Glycerol | 1.0 |
| NBP | 48.91 |

The viscosity at 100 s⁻¹ of the dope solution, measured as described above, is 10.50 Pa·s.

The separators S-1 to S-3 were prepared as schematically depicted in FIG. 2. The dope solution was coated on both sides of a 1.3 m wide PPS-fabric using slot die coating technology at a speed of 3 m/min. The flow rates at the slot coating dies (200 and 300, FIG. 2) were adjusted as shown in Table 2. The coated support was then transported towards a water bath (coagulation bath, 800) kept at 50° C. A VIPS step was carried out before entering the water bath in an enclosed area (400, d=7 cm, RH=98%, ventilation). The coated support then entered the water bath for 2 minutes during which a liquid induced phase separation (LIPS) occurred. After an in-line washing step at 65° C. during 5 minutes in water, the obtained separator was rolled up without drying, and afterwards cut in the desired format.

The obtained separators S-1 to S-3 have overlay thicknesses d1 and d2 and a total thickness D, as shown in Table 2. The gas permeability and the evaluation of the waviness of the separators, evaluated as described above, are shown in Table 2. A waviness indicated with OK means there is minimal waviness in the separator.

TABLE 2

| | S-1 (INV) | S-2 (COMP) | S-3 (COMP) |
|---|---|---|---|
| Q₁ (L · min⁻¹) | 0.45 | 0.55 | 0.34 |
| Q₂ (L · min⁻¹) | 0.65 | 0.55 | 0.76 |
| Q₁/Q₂ | 0.69 | 1 | 0.44 |
| d1 (μm) | 43 | 60 | 19 |
| d2 (μm) | 77 | 60 | 96 |
| d1/d2 | 0.56 | 1 | 0.2 |
| D (μm) | 220 | 220 | 184 |
| G.P (L/min · cm²) | 5.0 | 4 | 5.8 |
| Waviness | OK | NOK | OK |

From the results in Table 2 it is clear that preparing a separator by coating with different flow rates Q₁ and O₂ at the slot coating dies results in separator having an overlay thickness d1 that is smaller than the overlay thickness d2.

If the overlay thickness d1 is smaller than 20 μm, the gas permeability is too high. This is because the fibres of the porous support start to protrude the porous layer.

The waviness of the membrane is sufficiently good when d1/d2 is lower than 0.8.

1-15. (canceled)

16. A separator for alkaline electrolysis comprising a porous support, a first porous layer provided on one side of the porous support and a second porous layer provided on the other side of the porous support, wherein the first and the second porous layer are partially impregnated into the porous support and each have an overlay thickness d1 and d2 respectively, wherein said overlay thickness is defined as the part of each porous layer which is not impregnated into the porous support, characterized in that (a) d1 is smaller than the overlay thickness of the second porous layer (d2), and (b) d1 is at least 20 μm.

17. The separator of claim 16, wherein d1/d2 is 0.8 or less.

18. The separator of claim 17 having a thickness of 250 μm or less.

19. The separator of claim 16 having a thickness of 250 μm or less.

20. The separator of claim 16, wherein the porous support has a thickness from 50 to 150 μm.

21. The separator of claim 16, wherein the porous support has an open area from 30 up to 80%.

22. The separator of claim 16 having a gas permeability from 2 to 5.8 L/min·cm² measured at 5 bar.

23. The separator of claim 16 having an ionic resistance of less than 0.1 ohm·cm² at 80° C. in a 30 wt % aqueous KOH solution.

24. The separator of claim 16, wherein the first and second porous layer include a polymer resin and hydrophilic inorganic particles.

25. The separator of claim 24, wherein the polymer resin is at least one selected from the group consisting of polysulfone, polyethersulfone, polyphenylene sulfide, polyether ether ketone, and polyphenylsulfone.

26. The separator of claim 24, wherein the hydrophilic inorganic particles are selected from at least one of the group consisting of zirconium oxide, zirconium hydroxide, magnesium oxide, magnesium hydroxide, titanium oxide, titanium hydroxide, and bariumsulfate.

27. A method of manufacturing a separator for alkaline water electrolysis comprising the steps of:
(i) applying a dope solution including a polymer resin, hydrophilic inorganic particles and a solvent on both sides of a porous support, and
(ii) performing phase inversion on the applied dope solutions thereby forming the first porous layer on one side of the porous support and the second porous layer on the other side of the porous support,
characterized in that the first porous layer has an overlay thickness (d1) smaller than an overlay thickness of the second porous layer (d2).

28. The method of claim 27, wherein a first dope solution is applied at one side of the porous support at a flow rate Q₁, which is smaller than the flow rate Q₂ of a second dope solution at the other side of the porous support.

29. The method of claim 28, wherein Q₁/Q₂ is from 0.1 to 0.9.

30. The method of claim 27, wherein the overlay thickness of the first porous layer (d1) is at least 20 μm.

31. An alkaline water electrolysis device comprising a separator as defined in claim 16 located between a cathode and an anode.

32. An alkaline water electrolysis device comprising a separator as defined in claim 17 located between a cathode and an anode.

33. An alkaline water electrolysis device comprising a separator as defined in claim 18 located between a cathode and an anode.

34. An alkaline water electrolysis device comprising a separator as defined in claim 19 located between a cathode and an anode.

35. An alkaline water electrolysis device comprising a separator as defined in claim 20 located between a cathode and an anode.
